(19) United States
(12) Patent Application Publication
(10) Pub. No.: US 2022/0027968 A1
(43) Pub. Date: Jan. 27, 2022

(54) COMMODITY SALES DATA PROCESSING APPARATUS AND PROGRAM

(71) Applicant: TOSHIBA TEC KABUSHIKI KAISHA, Tokyo (JP)

(72) Inventor: Tomoki UENO, Numazu Shizuoka (JP)

(21) Appl. No.: 17/323,828

(22) Filed: May 18, 2021

(51) Int. Cl. G06Q 30/06

(52) U.S. Cl. CPC G06Q 30/0607; G06K 7/1413

(57) ABSTRACT

According to an embodiment, a commodity sales data processing apparatus includes a commodity-information acquiring unit configured to acquire commodity information for a commodity associated with a commodity code in a commodity master file. The commodity information includes an on-sale date for the commodity which indicates a particular day/time at which it is acceptable for the commodity to be sold to customers. A commodity identifying unit is configured to identify a first commodity based on the commodity code read from the first commodity. An information presenting unit is configured to cause an information presentation to be performed according to the present date/time and the on-sale date for the first commodity as acquired by the commodity-information acquiring unit for the first commodity.

### CROSS-REFERENCE TO RELATED APPLICATION

This application is based upon and claims the benefit of priority from Japanese Patent Application No. 2020-126500, filed Jul. 27, 2020, the entire contents of which are incorporated herein by reference.

### FIELD

Embodiments described herein relate generally to a commodity sales data processing apparatus and a commodity sales data processing program.

### BACKGROUND

When commodities are to be sold in a store, there may be occasions when certain products will have a specified on-sale date at which the store is permitted or requested to begin selling the product. However, in such scenarios, it is fairly common for the date-restricted product to be inadvertently sold before the intended date on-sale date or at least for a customer to attempt to purchase such a product early. To avoid such problems, a store clerk would have to check an on-sale date list or the like providing the on-sale date for each product being sold.

A sales price management system is known from Patent Literature 1 (JP-A-2003-123145) in which an on-sale date for commodities is kept.

However, the sales price management system described in Patent Literature 1 tracks the number of elapsed days from the on-sale date for the commodities and does not check the relationship between the present day (selling date) and the on-sale date for the commodities.

### BRIEF DESCRIPTION OF THE DRAWINGS

FIG. 1 depicts a POS terminal in a schematic perspective view according to a first embodiment.

FIG. 2 is a block diagram illustrating aspects of a POS terminal according to a first embodiment.

FIG. 3 depicts an example data structure of a commodity master according to a first embodiment.

FIG. 4 is a block diagram illustrating aspects of a POS terminal according to a first embodiment.

FIG. 5 is a flowchart illustrating an example of processing performed by a POS terminal according to a first embodiment.

FIG. 6 is a block diagram illustrating aspects of a portable terminal according to a second embodiment.

FIG. 7 is a diagram for explaining an example of a condition for determining whether display of commodities is possible according to a second embodiment.

FIG. 8 is a block diagram illustrating aspects of a portable terminal according to a second embodiment.

FIG. 9 is a flowchart illustrating an example of processing performed by a portable terminal according to a second embodiment.

### DETAILED DESCRIPTION

At least one embodiment provides a commodity sales data processing apparatus and a commodity sales data processing program that can check an on-sale date for commodities being processed.

According to an embodiment, a commodity sales data processing apparatus includes a commodity-information acquiring unit configured to acquire commodity information for a commodity associated with a commodity code in a commodity master file. The commodity information includes an on-sale date for the commodity. A commodity identifying unit is configured to identify a first commodity based on the commodity code read from the first commodity. An information presenting unit is configured to cause an information presentation to be performed according to the present date/time and an on-sale date for the first commodity as acquired by the commodity-information acquiring unit for the first commodity.

### First Embodiment

Configuration of POS Terminal

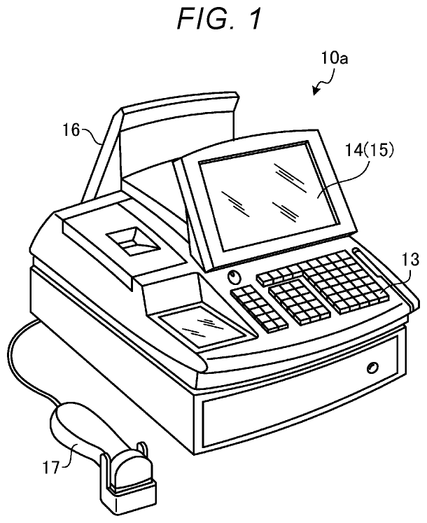

FIG. 1 is a schematic perspective view of a POS terminal in the first embodiment. In the first embodiment, a POS terminal 10a placed in a store such as a supermarket or a retail store performs a registration process for registering a commodity being purchased by a customer and a payment process of settling the registered commodity. The POS terminal 10a is an example of an information processing apparatus or a commodity sales data processing apparatus in the present disclosure.

The POS terminal 10a includes a keyboard 13, a monitor 14 for the store clerk, a monitor 16 for the customer, and a barcode reader 17.

The keyboard 13 includes a plurality of keys such as numeric keys, a clear key, a return key, a closing key, a deposit and cash total key. The numeric keys are ten keys for inputting a numerical value such as a commodity code, price, or an amount. The clear key is for cancelling an operation, for example, if an error occurs. The return key is for cancelling the present operation and returning to the immediately preceding screen or the like. The closing key is for declaring the completion of the sales registration and requesting calculation of a sales total amount (amount due in the sales transaction). The deposit and cash total key is for requesting the calculation of a change due amount after the input of an amount deposited by a customer as payment.

The monitor 14 includes a display device such as a Liquid Crystal Display (LCD). The monitor 14 displays, to the store clerk operating the POS terminal 10a, a screen corresponding to present processing stage of the registration process, the payment process, and the like.

A touch panel 15 can be laminated on the surface of the display device of the monitor 14. The touch panel 15 detects pressing by the store clerk on a screen, a button, or the like displayed on the monitor 14 and controls the operation of the POS terminal 10a according to a pressed position. The store clerk performs necessary input operation using one or both of the keyboard 13 and the touch panel 15.

The monitor 16 includes a display device such as an LCD and provided on an upper portion of the POS terminal 10a opposite to the monitor 14. The monitor 16 has a display surface directed towards a customer and displays sale prices, a total amount due, and the like for registered commodities.

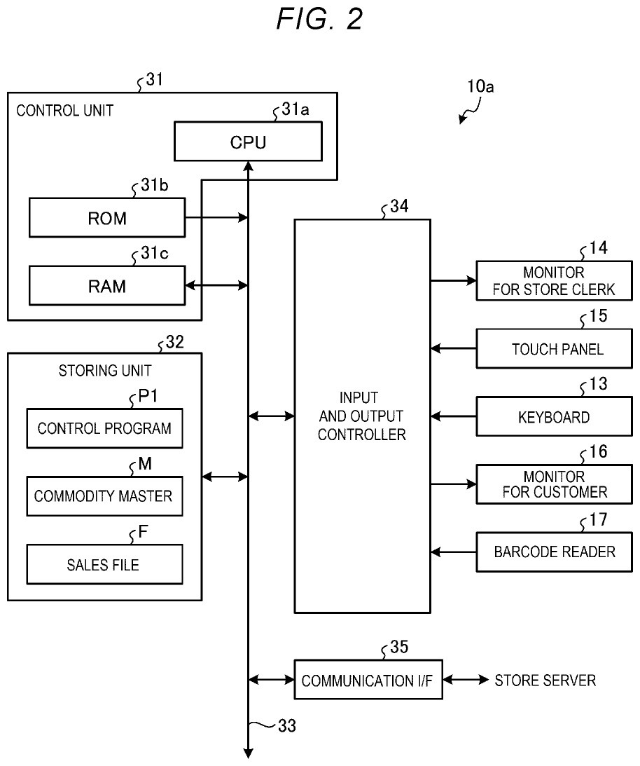

The barcode reader 17 that reads a commodity code registered in a barcode of a commodity is connected to the POS terminal 10a. The barcode reader 17 decodes a light reception signal received from a code symbol, acquires a commodity code recorded in the code symbol, and outputs the commodity code to a CPU 31a (see FIG. 2) of the POS terminal 10a. The POS terminal 10a may include a scanner capable of reading a two-dimensional code besides the barcode reader 17. The POS terminal 10a may include a scanner having an object recognizing function for capturing an image of a commodity to recognize the commodity based on the captured image.

Hardware Configuration of POS Terminal

In the first embodiment, as shown in FIG. 2, the POS terminal 10a includes a control unit (or a controller) 31, a storing unit 32, an input and output controller 34, and a communication I/F 35.

The control unit 31 manages control of the POS terminal 10a. The control unit 31 has a configuration of a computer including a Central Processing Unit (CPU) 31a, a Read-Only Memory (ROM) 31b, and a Random-Access Memory (RAM) 31c. The CPU 31a loads, in the RAM 31c, various programs stored in the ROM 31b and the storing unit 32. The CPU 31a operates according to the various programs loaded in the RAM 31c and manages the control of the POS terminal 10a.

The control unit 31 is connected to the storing unit 32, the input and output controller 34, and the communication I/F 35 via an internal bus 33.

The storing unit 32 is, for example, a nonvolatile memory such as a HDD (Hard Disk Drive) and a flash memory in which stored information is retained even if a power supply is turned off. The storing unit 32 stores programs and the like including a control program P1. The control program P1 is for exerting functions of the POS terminal 10a.

The control program P1 may be incorporated in advance in the ROM 31b. The control program P1 may be provided to the control unit 31 by a computer-readable recording medium such as a CD-ROM, a flexible disk (FD), a CD-R, or a DVD in which the program P1 is recorded as a file of an installable format or an executable format. Further, the control program P1 may be stored on a computer connected to a network such as the Internet and provided to the POS terminal 10a by being downloaded through the network. The control program P1 may be provided or distributed through the network such as the Internet.

The storing unit 32 stores a commodity master M and a sales file F.

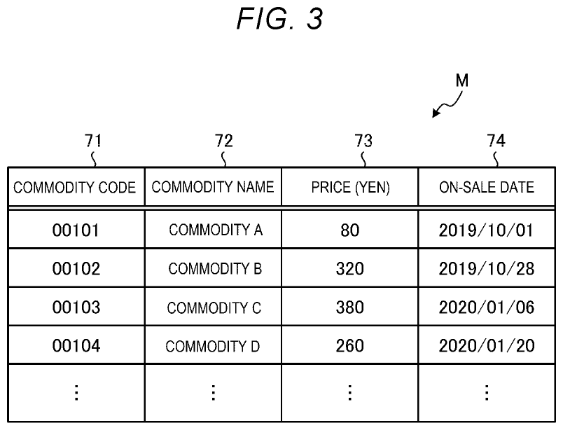

The commodity master M is a master file storing a commodity name, a price, an on-sale date, and the like in association with a commodity code specific to a commodity. Since content of the commodity master M is updated every day, the POS terminal 10a periodically receives the latest file of the commodity master M from an external device such as a store server via the communication I/F 35. A specific example of a data configuration for a commodity master M is explained below (see FIG. 3).

The sales file F is a file storing results from completed sales transactions and the like performed at the POS terminal 10a. The sales file F provides a sales history of the POS terminal 10a. The sales file F can be transmitted to the store server via the communication I/F 35 at a fixed time such as after close of business every day. The transmitted sales file(s) F is used for sales management purposes by the store and are maintained in the store server.

The input and output controller 34 connects the control unit 31 to various peripheral devices. In the case of the POS terminal 10a according to the first embodiment, the peripheral devices are the monitor 14, the touch panel 15, the keyboard 13, the monitor 16, and the barcode reader 17. The peripheral devices connected to the POS terminal 10a are not limited to these devices. Other peripheral devices, for example, a receipt printer and a card reader may also be connected to the POS terminal 10a.

The communication I/F 35 is a communication controller for performing wireless communication or wired communication between the POS terminal 10a and the store server, which is one example of the external device in the first embodiment. The POS terminal 10a receives the latest commodity master M from the store server. The POS terminal 10a transmits the sales file F to the store server.

Configuration of Commodity Master

An example configuration of a commodity master M is explained with reference to FIG. 3. FIG. 3 is a diagram illustrating an example of a data structure of the commodity master.

As shown in FIG. 3, the commodity master M in the first embodiment correlates information concerning a commodity (or commodity information) such as a commodity name 72, a price 73, and an on-sale date 74 to a commodity code 71 for each commodity and stores such commodity information. The commodity code 71 is identification information uniquely set for each commodity and is used to identify the commodity. The POS terminal 10a reads a barcode attached to the commodity with the barcode reader 17. The POS terminal 10a acquires a commodity code by decoding information read by the barcode reader 17. The POS terminal 10a uniquely identifies the commodity by collating the acquired commodity code with the commodity code 71 of the commodity master M.

The commodity name 72 is uniquely correlated with the commodity code 71.

The price 73 is a unit price of the commodity uniquely correlated with the commodity code 71.

The on-sale date 74 is a scheduled date on which the commodity uniquely correlated to the commodity code 71 is to be sold at the store. For example, the particular date set as on-sale date 74 can be set by a product manufacturer, a product distributor, a corporate headquarters, a store manager, or the like.

Functional Configuration of POS Terminal

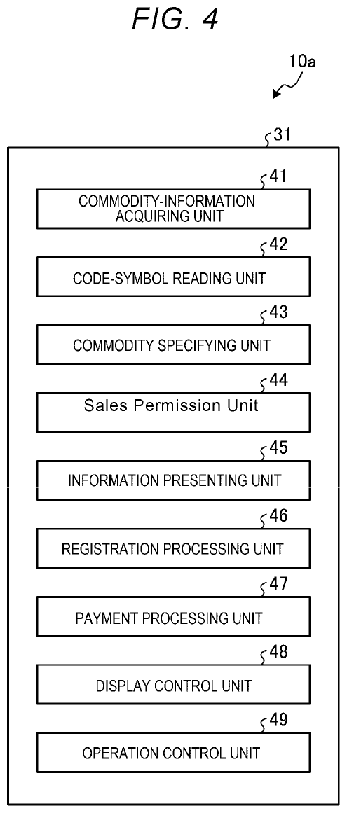

Various functions of the POS terminal 10a are explained with reference to FIG. 4. FIG. 4 is a block diagram illustrating aspects related to a functional configuration of the POS terminal 10a in the first embodiment.

Referring to FIGS. 2 and 4, the control unit 31 of the POS terminal 10a according to the first embodiment loads the control program P1 in the RAM 31c and causes the control program P1 to be executed to realize, as functional units, a commodity-information acquiring unit 41, a code-symbol reading unit 42, a commodity identifying unit 43, a sales permission unit 44, an information presenting unit 45, a registration processing unit 46, a payment processing unit 47, a display control unit 48, and an operation control unit 49.

The commodity-information acquiring unit 41 acquires commodity information correlated with a commodity code and an on-sale date of each commodity available at a store.

The code-symbol reading unit 42 reads a commodity code recorded in a code symbol attached to each commodity with the barcode reader 17.

The commodity identifying unit 43 uniquely identifies a selected commodity, which is a specific commodity that has been selected by a customer for purchase, based on a commodity code read from the selected commodity and the commodity information correlated with the read commodity code.

The sales permission unit 44 compares an on-sale date of the selected commodity identified by the commodity identifying unit 43 to the present date and time acquired from the CPU 31a and determines whether the identified commodity can be sold at the present point in time.

The information presenting unit 45 performs, or causes to be performed, an information presentation corresponding to the on-sale date of the identified commodity and the present date and time. For example, if the sales permission unit 44 determines that the identified commodity cannot be sold at the present point in time, the information presenting unit 45 displays, for example, on the monitor 14, information indicating that the commodity cannot yet be sold due to the present date and time being before the scheduled on-sale date. The store clerk can then confirm with the display of such information on the monitor to explain the situation to the customer. The clerk can return the commodity to the stockroom or the like. The information presenting unit 45 may also display the same or similar information on the monitor 16 to notify the customer.

The registration processing unit 46 performs a registration process for registering a commodity to be sold.

The payment processing unit 47 performs the payment process by cash settlement or cashless settlement based on a result of the registration process by the registration processing unit 46.

The display control unit 48 controls contents, display timings, and the like of various kinds of information displayed on the monitor 14 and the monitor 16.

The operation control unit 49 causes the POS terminal 10a to perform operation corresponding to operation information input from the keyboard 13 and the touch panel 15.

The present disclosure can also be applied to a so-called self-service POS terminal with which a customer can perform the registration process and the payment process. In the case of the self-service POS terminal, for example, the information presenting unit 45 notifies the customer of the scheduled on-sale date of a certain commodity and calls a store clerk if it is determined that the commodity cannot be sold at the present point in time. The called store clerk may explain to a customer and return the commodity to a stockroom or the like until the scheduled time for sale.

Flow of Processing by POS Terminal

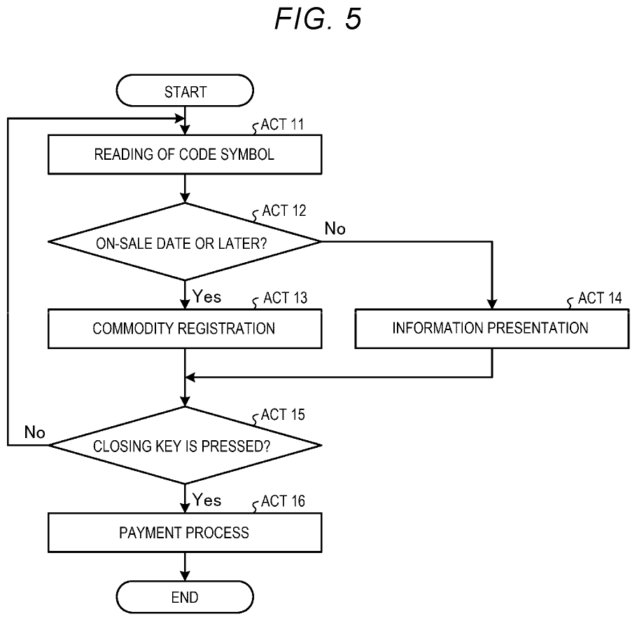

A flow of processing performed by the POS terminal 10a is explained with reference to FIG. 5. FIG. 5 is a flowchart illustrating an example of processing performed by the POS terminal 10a in the first embodiment.

Processing begins with when the code-symbol reading unit 42 identifies a commodity code encoded in a code symbol attached to a commodity based on a reading result from the barcode reader 17 (ACT 11).

In ACT 12, sales permission unit 44 then determines whether the present date and time acquired from the CPU 31a is before the on-sale date for the commodity with the code symbol that was read in ACT 11. If the present date and time is the on-sale date or later (Yes in ACT 12), the processing proceeds to ACT 13. If the present date and time is before the on-sale date (No in ACT 12), the processing proceeds to ACT 14.

If it is determined Yes in ACT 12, then the registration processing unit 46 performs commodity registration (ACT 13). Thereafter, the processing proceeds to ACT 15.

On the other hand, if it is determined No in ACT 12, the information presenting unit 45 displays information indicating that the commodity cannot be sold on the monitor 14 of the POS terminal 10a (ACT 14). Thereafter, the processing proceeds to ACT 15.

The operation control unit 49 determines whether the closing key of the POS terminal 10a has been pressed (ACT 15). If the closing key has been pressed (Yes in ACT 15), the processing proceeds to ACT 16. On the other hand, if the operation control unit 49 does not the closing key has been pressed (No in ACT 15), the processing returns to ACT 11, and the commodity registration for the next commodity being purchased will be performed.

If the closing key is pressed (Yes in ACT 15), the payment processing unit 47 performs payment process by cash settlement or cashless settlement method for the commodities registered in the registration process by the registration processing unit 46. Once the payment process is complete, the POS terminal 10a ends the processing.

In the POS terminal 10a according to the first embodiment, the commodity information acquiring unit 41 obtains information for a commodity with a commodity code that has been registered. The on-sale date of the commodity is included in the acquired information for the commodity. The commodity identifying unit 43 identifies the selected commodity based on its commodity code. The information presenting unit 45 performs an information presentation based the on-sale date for the commodity and the present date and time. Therefore, the on-sale date of the commodity can be checked without performing manual collation or the like or checking of the commodity code against a printed listing or the like.

In the POS terminal 10a of the first embodiment, the information presenting unit 45 performs a notification indicating that the commodity cannot be purchased if the on-sale date of the commodity has not yet arrived. This makes it possible to surely prevent a sale of a commodity before its scheduled on-sale date.

### Second Embodiment

A portable terminal 10b according to a second embodiment is, for example, a personal digital assistance (PDA) or a smartphone carried by a store clerk who performs shelf stocking or restocking by carrying commodities from a back office or a stockroom and putting the commodities on the display shelves or the like. If the store clerk is the (re)stocking shelves by reading barcodes of the commodities being placed on the shelves, the store clerk can confirm on-sale dates for the commodities being placed on display have arrived by comparison to the commodity master. The portable terminal 10b is an example of an information processing apparatus in the present disclosure.

Hardware Configuration of Portable Terminal

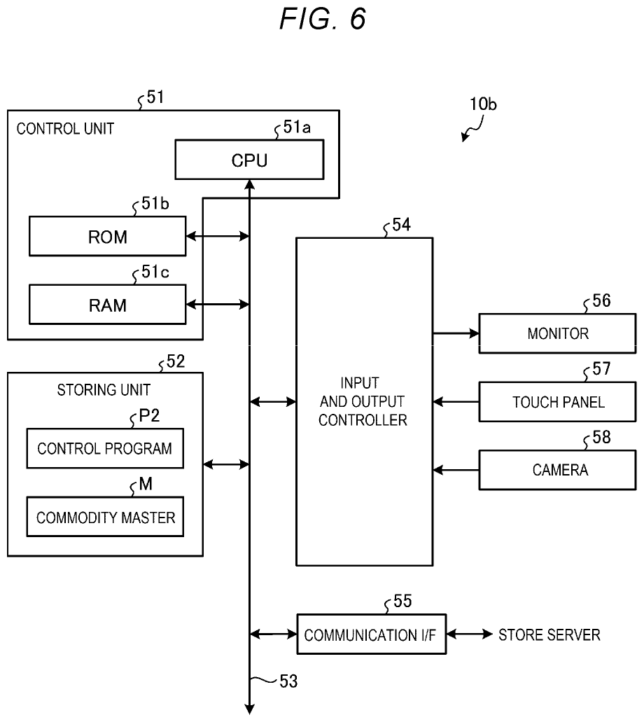

A hardware configuration of the portable terminal 10b is explained with reference to FIG. 6. FIG. 6 is a block diagram illustrating an example of a hardware configuration of a portable terminal 10b in the second embodiment. As shown in FIG. 6, the portable terminal 10b according to the second embodiment includes a control unit 51, a storing unit 52, an input and output controller 54, and a communication I/F 55.

The control unit 51 manages operations of the portable terminal 10b. The control unit 51 has a configuration of a computer including a CPU 51a, a ROM 51b, and a RAM 51c. The CPU 51a loads, in the RAM 51c, various programs stored in the ROM 51b and the storing unit 52. The CPU 51a operates according to the various programs loaded in the RAM 51c to manage the control of the portable terminal 10b.

The control unit 51 is connected to the storage unit 52, the input and output controller 54, and the communication I/F 55 via an internal bus 53.

The storing unit 52 is, for example, a nonvolatile memory such as an HDD or a flash memory in which stored information is retained even if a power supply is turned off. The storing unit 52 stores programs and the like including a control program P2. The control program P2 is for exerting functions of the portable terminal 10b.

The storing unit 52 stores a commodity master M. Content of the commodity master Min this context is the same as explained for the first embodiment.

The input and output (I/O) controller 54 connects the control unit 51 to various peripheral devices. In the case of the portable terminal 10b of the second embodiment, the peripheral devices are a monitor 56, a touch panel 57, and a camera 58.

The monitor 56 is a display device such as an LCD that is included in the portable terminal 10b and displays information concerning the (re)stocking of the display shelves or the like.

The touch panel 57 is laminated on the surface of the monitor 56. The touch panel 57 detects touching or pressing by the store clerk on a screen, a button, or the like displayed on the monitor 56 and controls the operation of the portable terminal 10b according to a touched or pressed position.

The camera 58 is incorporated in the portable terminal 10b and captures an image of a code symbol (such as a barcode or a two-dimensional code) attached to each commodity.

The communication I/F 55 is a communication controller for performing wireless communication between the portable terminal 10b and an external device such as a store server. The portable terminal 10b receives the latest commodity master M from the store server. The portable terminal 10b acquires information of business hours of the store and holidays or closed business days of the store from the store server. The portable terminal 10b transmits information indicating the commodities for which the stocking has been completed.

Date/time restrictions for commodities to be stocked on display shelves or the like.

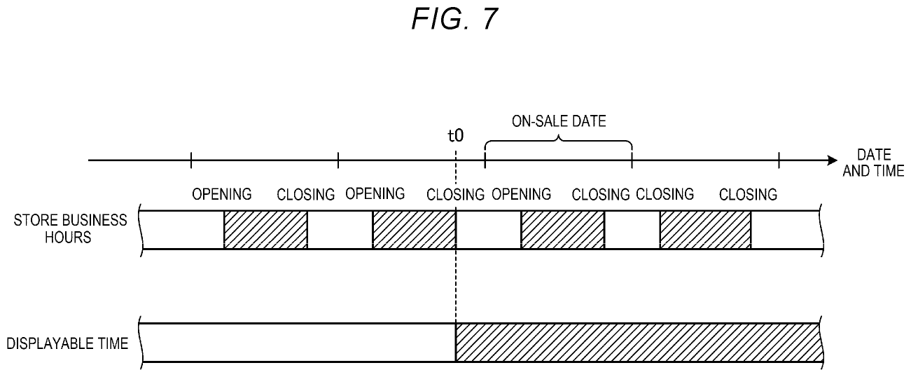

Timing related to the placing of on-sale date restricted commodities on display (shelf stocking) is explained with reference to FIG. 7. FIG. 7 is a diagram for explaining a condition related to whether certain commodities are permitted to be stocked/displayed on the store shelves in the context of the second embodiment.

For discussing the example shown in FIG. 7, the on-sale date of a certain commodity is referred to as on-sale date D, and stocking shelves with such commodities is permitted to be first performed after closing time t0 on the day before the on-sale date D such that these commodities will be available upon store opening on the particular on-sale date D.

In this example, the portable terminal 10b acquires the on-sale date D of the commodity in question from the commodity master M from the store server or the like. The portable terminal 10b also acquires the present date and time from the CPU 51a. Furthermore, the portable terminal 10b acquires the business hours for the store from the store server. The business hours include information indicating store open times and store closed times.

When the store clerk who is performing the shelf stocking reads a code symbol attached to the commodity that is about to be placed on the shelf or just placed on the shelf using the camera 58, the portable terminal 10b determines, based on the on-sale date D of the commodity, the present date and time, and the business hours of the store, whether it is permitted to perform display the commodity in the store (e.g., place the commodity on the display shelves). If stocking/display is not yet permitted, the portable terminal 10b displays, on the monitor 56, information indicating that the stocking shelves cannot be performed.

The portable terminal 10b may further acquire information of store holidays or closed business days from the store server and use the information to determine whether and when the shelf-stocking can be done for date restricted commodities. For example, if the day before the scheduled on-sale date of the commodity in question is a holiday (store is closed), the portable terminal 10b may determine that the commodity is permitted to stocked and/or displayed on a shelf or the like starting from the closing time of the store on the day before the store holiday.

Functional Configuration of Portable Terminal

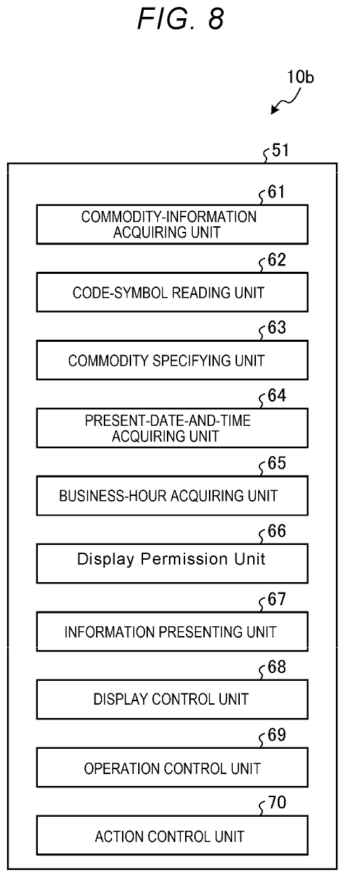

A functional aspects of the portable terminal 10b are explained with reference to FIG. 8. FIG. 8 is a block diagram illustrating an example of a functional configuration of the portable terminal 10b in the second embodiment.

The control unit 51 of the portable terminal 10b loads the control program P2 onto the RAM 51c and causes the control program P2 to be executed to realize, as functional units, a commodity-information acquiring unit 61, a code-symbol reading unit 62, a commodity identifying unit 63, a present-date-and-time acquiring unit 64, a business-hour acquiring unit 65, a display permission unit 66, an information presenting unit 67, a display control unit 68, an operation control unit 69, and an action control unit 70.

The commodity-information acquiring unit 61 acquires commodity information correlated with a commodity code and an on-sale date of each commodity available at a store from the commodity master M. The commodity-information acquiring unit 61 correlates business hours including at least closing time of the store acquired by the business-hour acquiring unit 65 with the commodity information. The business hours including the closing time of the store are an example of the commodity display information in the present disclosure.

The code-symbol reading unit 62 reads a commodity code recorded in a code symbol attached to each commodity from an image of the code symbol captured by the camera 58.

The commodity identifying unit 63 uniquely identifies a selected commodity, which is a specific commodity that has been selected for shelf-stocking by, for example, a store clerk, based on its commodity code and commodity information.

The present-date-and-time acquiring unit 64 acquires the present date and time from, for example, the CPU 51a.

The business-hour acquiring unit 65 acquires the business hours including at least the closing time of the store from the store server. The business-hour acquiring unit 65 may acquire the business hours including the closing time of the store stored in advance in the storing unit 52. The business-hour acquiring unit 65 may further acquire the holidays or closed business days of the store.

The display permission unit 66 determines whether the commodity identified by the commodity identifying unit 63 can be displayed on a shelf or the like for sale in the store at the present date and time.

For example, the display permission unit 66 compares the on-sale date of the commodity, the present date and time, and the closing time of the store. If the present date and time is the on-sale date or later or, alternatively, the present date and time is after the store closing time on the day before the on-sale date of the commodity, the display permission unit 66 determines that the commodity can be displayed for sale.

The display permission unit 66 may compare the on-sale date of the identified commodity, the present date and time, and the closing time and holidays of the store. Ina case where the present date and time is the same as or later than on-sale date of the commodity or where the present date and time is the same as or later than the closing time of the store on the day before the on-sale date of the identified commodity or where the day before the on-sale date of the identified commodity is a holiday of the store, the display permission unit 66 may determine that the commodity can be displayed for sale when the present date and time is on or after the closing time of the store on the day before the store holiday.

The information presenting unit 67 performs, or causes to be performed, an information presentation according to the on-sale date of the identified commodity and the present date and time. In some examples, the information presenting unit 67 may perform, or cause to be performed, an information presentation according to the on-sale date of the identified commodity, the present date and time, and the closing time of the store. In still further examples, the information presenting unit 67 may perform, or cause to be performed, an information presentation according to the on-sale date of the identified commodity, the present date and time, and the closing time and holiday of the store.

If the identified commodity should not be displayed on a shelf or the like at the present date and time, the information presenting unit 67 displays, on the monitor 56 of the portable terminal 10b, information indicating that the commodity cannot be displayed for sale yet. At this time, the information presenting unit 67 may also display the scheduled date and time when the commodity can be displayed.

The display control unit 68 sets contents, display timings, and the like of various kinds of information displayed on the monitor 56.

The operation control unit 69 causes the portable terminal 10b to perform operation corresponding to operation information input from the touch panel 57.

The action control unit 70 controls part or all of the actions, processes, and the like relating to the shelf-stocking of the commodities performed by a store clerk or the like using the portable terminal 10b.

Flow of Processing by Portable Terminal

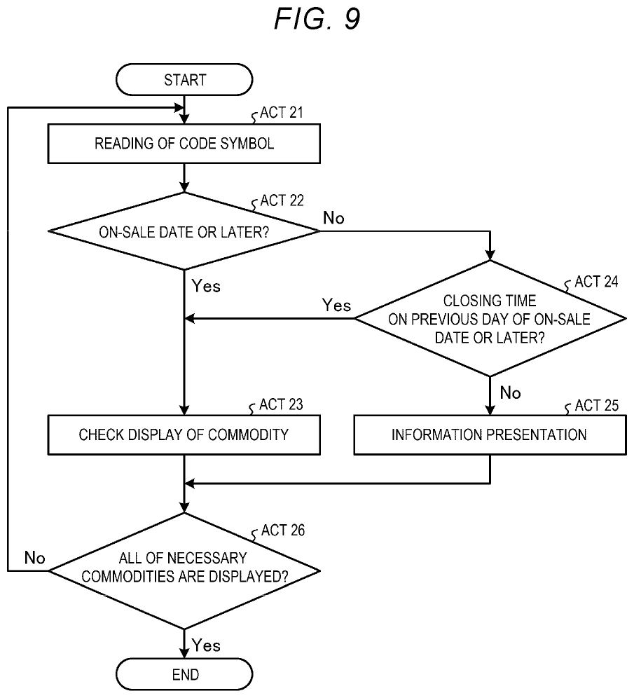

A flow of processing performed by the portable terminal 10b is explained with reference to FIG. 9.

The code-symbol reading unit 62 reads a commodity code encoded in a code symbol attached to a certain commodity that has been selected by a store clerk for shelf-stocking (ACT 21).

The display permission unit 66 determines whether the present date and time is the same as or later than the on-sale date of the commodity identified based on the commodity code in ACT 21 (ACT 22). If the display permission unit 66 determines that the present date and time is the same as or later than the on-sale date (Yes in ACT 22), the processing proceeds to ACT 23. Otherwise (No in ACT 22), the processing proceeds to ACT 24.

If Yes is determined in ACT 22, a store clerk in charge of stocking shelves will place the commodity on display then and confirms the commodity has been display via input operation on a commodity list or the like displayed on the monitor 56 (ACT 23). Thereafter, the processing proceeds to ACT 26.

On the other hand, if No is determined in ACT 22, the display permission unit 66 then determines whether the present date and time is the same as or later than the closing time on the day before the on-sale date of the identified commodity (ACT 24). If the display permission unit 66 determines that the present date and time is the same as or later than the closing time on the day before the on-sale date of the identified commodity (Yes in ACT 24), the processing proceeds to ACT 23. On the other hand, if the present date and time is not on or after the closing time on the day before the on-sale date of the commodity (No in ACT 24), the processing proceeds to ACT 25.

If No is determined in ACT 24, the information presenting unit 67 displays, on the monitor 56 of the portable terminal 10b, information indicating that the commodity cannot be displayed for sale yet (ACT 25). Thereafter, the processing proceeds to ACT 26.

The action control unit 70 determines, by referring to, for example, a commodity list, whether all commodities that need to be displayed (stocked) have been displayed (stocked) on a shelf or the like (ACT 26). If the action control unit 70 determines that all the commodities that need to be displayed have been displayed (Yes in ACT 26), the portable terminal 10b ends the processing illustrated in FIG. 9. On the other hand, if all the commodities that need to be displayed have not been displayed (No in ACT 26), the portable terminal 10b returns to ACT 21 and repeats the processing.

Although not specifically illustrated in the flowchart of FIG. 9, the display permission unit 66 may further determine whether the commodity may be displayed before the on-sale date depending on potentially intervening store holidays or closed days.

In the portable terminal 10b according to the second embodiment, the commodity-information acquiring unit 61 acquires the commodity information correlated with commodity display information such as the on-sale date of the commodity and the store business hours including the store closing time. Therefore, it is possible to correctly determine the date and time at which the commodity can be appropriately displayed on a shelf or the like for sale in a store.

In the portable terminal 10b of the second embodiment, the business-hour acquiring unit 65 acquires at least the closing time of the store that sells the commodity. The information presenting unit 67 performs the information presentation corresponding to the on-sale date of the commodity identified by the commodity identifying unit 63, the present date and time, and the closing time of the store. Therefore, it is possible to present information indicating that the commodity can be displayed on a shelf or the like after the closing time of the store on the previous day of the on-sale date of the commodity.

In the portable terminal 10b of the second embodiment, the business-hour acquiring unit 65 further acquires the holiday schedule of the store. The information presenting unit 67 performs the information presentation corresponding to the on-sale date of the commodity identified by the commodity identifying unit 63, the present date and time, the closing time of the store, and the scheduled holidays of the store. Therefore, it is possible to present information indicating that the commodity can be displayed on a shelf or the like after the closing time of the store on the day before the holiday.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity sales data processing apparatus, comprising:
a commodity-information acquiring unit configured to acquire commodity information for a commodity associated with a commodity code in a commodity master file, the commodity information including an on-sale date for the commodity;
a commodity identifying unit configured to identify a first commodity based on the commodity code read from the first commodity; and
an information presenting unit configured to cause an information presentation to be performed according to the present date and time and an on-sale date for the first commodity acquired by the commodity-information acquiring unit for the first commodity.

2. The commodity sales data processing apparatus according to claim 1, wherein the commodity identifying unit is a barcode reader.

3. The commodity sales data processing apparatus according to claim 1, further comprising:
a display screen, wherein the information presenting unit cause the information presentation to be performed on the display screen.

4. The commodity sales data processing apparatus according to claim 1, wherein the information presenting unit is further configured to perform the information presentation including a notification indicating that the first commodity cannot be purchased if the on-sale date of the first commodity is after the present date.

5. The commodity sales data processing apparatus according to claim 1, wherein the information presenting unit is further configured to perform the information presentation including a notification indicating that the first commodity can be displayed at a store if the present date and time corresponds to a store closing time one business day before the on-sale date of the first commodity.

6. The commodity sales data processing apparatus according to claim 1, further comprising:
a business-hour acquiring unit configured to acquire a store closing time, wherein
the information presenting unit performs the information presentation corresponding to the on-sale date of the first commodity, the present date and time, and the store closing time.

7. The commodity sales data processing apparatus according to claim 6, wherein
the business-hour acquiring unit further acquires a store holiday schedule, and
the information presenting unit performs the information presentation corresponding to the on-sale date of the selected commodity, the present date and time, the store closing time, and the store holiday schedule.

8. An information processing apparatus, comprising:
a controller configured to:
acquire a commodity code that has been read from a first commodity;
acquire commodity information for the first commodity associated with the commodity code in a commodity master file, the commodity information including an on-sale date for the first commodity; and
cause a notification to be performed according to the present date and time and the on-sale date for the first commodity.

9. The information processing apparatus according to claim 8, further comprising:
a commodity code reader configured to read the commodity code from the first commodity.

10. The information processing apparatus according to claim 8, wherein the controller is further configured to:
cause the notification to indicate that the first commodity cannot be purchased when the present date is before the on-sale date for the first commodity.

11. The information processing apparatus according to claim 8, wherein the controller is further configured to:
cause the notification to indicate that the first commodity cannot be displayed for sale when the present date is not the same as or later than the on-sale date.

12. The information processing apparatus according to claim 8, wherein the controller is further configured to:
acquire a store closing time; and
cause the notification to indicate that the first commodity can be displayed for sale when the present date and time is on or after the store closing time one business day before the to the on-sale date of the first commodity.

13. The information processing apparatus according to claim 8, further comprising:
a communication interface, wherein
the commodity master is stored on a store server.

14. A non-transitory computer-readable medium storing a program that when executed causes a computer to perform a commodity sales data process comprising:
acquire a commodity code that has been read from a first commodity;
acquire commodity information for the first commodity associated with the commodity code in a commodity master file, the commodity information including an on-sale date for the first commodity; and
cause a notification to be performed according to the present date and time and the on-sale date for the first commodity.

15. The non-transitory computer-readable medium according to claim 14, the commodity sales data process further comprising:
read the commodity code from the first commodity.

16. The non-transitory computer-readable medium according to claim 14, wherein the commodity master file is stored on a store server.

17. The non-transitory computer-readable medium according to claim 14, wherein the commodity sales data process further comprises:
cause the notification to indicate that the first commodity cannot be purchased when the present date is before the on-sale date for the first commodity.

18. The non-transitory computer-readable medium according to claim 14, wherein the commodity sales data process further comprises:
cause the notification to indicate that the first commodity cannot be purchased when the present date is before the on-sale date for the first commodity.

19. The non-transitory computer-readable medium according to claim 14, wherein the commodity sales data process further comprises:
acquire a store closing time; and
cause the notification to indicate that the first commodity can be displayed for sale when the present date and time is on or after the store closing time one business day before the to the on-sale date of the first commodity.

20. The non-transitory computer-readable medium according to claim 19, wherein the commodity sales data process further comprises:
acquire a store holiday schedule.
